(19) United States
(12) Patent Application Publication
(10) Pub. No.: US 2012/0000044 A1
(43) Pub. Date: Jan. 5, 2012

(54) Self boring vertical burial containers

(76) Inventor: Donald E. Scruggs, Chino, CA (US)

(21) Appl. No.: 13/136,962

(22) Filed: Aug. 16, 2011

Related U.S. Application Data
(63) Continuation-in-part of application No. 12/587,550, filed on Oct. 8, 2009, now Pat. No. 8,046,883.

(51) Int. Cl. A61G 17/00; A61G 99/00; A61G 19/00

(52) U.S. Cl. 27/2; 27/32

(57) ABSTRACT

A space saving burial container that bores its own hole and efficiently guides the cut away receiving material up and out of the hole to inter a fully secured body in a permanently natural upright position.

### CROSS-REFERENCE TO RELATED APPLICATIONS

Continuation in Part of 12/587,550 Edged Non-Horizontal Burial Containers.

### FEDERALLY SPONSORED RESEARCH

Not applicable

### SEQUENCE LISTING OR PROGRAM

Not applicable

### FIELD OF THE INVENTION

This invention relates to conserving cemetery space by using easy to install burial containers which can be self bored into earth or other receiving materials and do not require a large amount of land area or a large pre-dug rectangular hole.

### BACKGROUND OF THE INVENTION

A common current interment practice is to first move a body to a mortuary where it is prepared for funeral services. In cases where a body is unclaimed, it is usually provided with minimum preparation and burial, paid for by public funds. A claimed body, after mortuary preparation, is usually placed in an aescetically pleasing casket and either displayed in an open casket funeral service or the casket alone is visible in a closed casket service. Often, after an indoor service the body and casket are moved to a prepared grave site in a cemetery, where a final service is performed.

At the prepared grave site the casket containing the body is set either on or in a box like crypt during a grave side funeral service, if one is conducted. None of these burial services need be changed for the use of a Self Boring Vertical Burial Container. Several types of these burial containers are designed to be set on floral or otherwise decorated boxes for open or closed casket funeral services in an in door or out door environment.

Currently the prepared grave is often a rectangular excavation approximately four feet wide by seven and a half feet long by six and a half feet deep. Walkways are left on all sides of the grave for later visitors, making about 50 square feet of ground area to be set aside for each grave. A Self Boring Vertical Burial Container requires only about one third of the space used for a current horizontal burial.

The removed receiving material from the current type grave excavation is usually piled next to the grave site and covered during a grave side funeral service, if one is conducted. After funeral services, the casket and or box like crypt is lowered to the bottom of the prepared grave excavation and the removed receiving material is shoveled back into the excavation. Ground cover, such as grass, is then restored over the site. In a Self Boring Vertical Burial Container burial only a very small amount of ground cover needs to be replaced.

In current type burials, additional digging and preparation is often undertaken to provide for the installation of a headstone, plaque marker or monument and the installation of flower and flag receptacles for persons to later pay respects and honor the deceased. Flower and flag receptacles and provisions for plaques, markers and monuments, are regularly built into the tops or head pieces of Self Boring Vertical Burial Containers.

Cemetery properties are usually selected and developed in costly, but pleasant areas with level and softer earth or other receiving materials. Roads, landscaping, fences, monuments, statues, trees, ponds and other items are added for utility and aesthetics. The cost of each grave site, and thus each burial, is relative to the number of grave sites on the developed cemetery property. The business of a cemetery is based on the number of grave sites available in the cemetery. With the Self Boring Vertical Burial Container method a cemetery has about three times the potential grave sites as in current horizontal burial practice. In addition, the invented containers can be readily installed in ponds, corners and steeply sloped land adding greatly to the available grave site total in a cemetery.

All in all, the Self Boring Vertical Burial Container method significantly reduces the cost of each grave site and each burial and provides for a tripling of the business potential for each existing old and new cemetery.

### OBJECTS OF THE INVENTION

It is a main object of this invention to greatly reduce the cost of each grave site by significantly reducing the land area required for each burial.

It is another object of this invention to reduce the cost of a burial by significantly reducing the amount of excavation and replacement of receiving material.

It is an object of this invention to greatly reduce the secondary labor currently required to finish a grave site after interment by providing for plaque, monument, flag and flower placement as an integral part of the burial container.

### OPERATING PRINCIPALS AND PREFERRED EMBODIMENT

The preferred embodiment of this invention is a Self Boring Vertical Burial Container with a strong hull, tapered from an upper head end toward a lower foot end and having cutting edges extending outward from the foot end perpendicular or at a lesser angle to a diameter larger than that of the upper head end of the container and having receiving material guides starting along the upper edges of the cutting edges and extending upward along the length of the hull to just below the wrenchable portion of the upper part of the container and to a diameter larger than that of the hull. When such a burial container is rotated in the correct direction the cutting edges at the lower foot end of the hull remove about the same volume of receiving material as can be guided up and out by the guides extending outward farther than the hull wall surface and creating space between the hull and the hole being bored by the container. Power equipment on a vehicle grips the burial container and attaches a wrench to the drivable upper head end of the burial container and holds the container in place while it rotates the container to make the interment. The body to be interred is not affected by the motion as it is securely encapsulated within the container to stand proudly tall for all time.

### DESCRIPTION OF FIGURES

FIG. 1 is a side view of an open Self Boring Vertical Burial Container with self digging cutting edges, 100, and guides, 105, and a hull split lengthwise into an upper lid segment, 101, and a lower main section, 103, as is common practice in current coffins and caskets, with a body, 102, inside, and being stabilized and held level by blocks, 104, for funeral display.

FIG. 2 is an end view of a Self Boring Vertical Burial Container illustrating the positions of a raised lid segment, 101, a body 102, a lower main section, 103, and support blocks, 104.

FIG. 3 is a side view of a Self Boring Vertical Burial Container in a closed position showing guides, 105, which guide the cut away receiving material to the surface, and added on cutting edges, 106.

FIG. 4 is a side view of the foot end only of a Self Boring Vertical Burial Container with cutting edges, 108, set at and angle other than perpendicular to the main axis of the burial container.

FIG. 5 is an end view of a Self Boring Vertical Burial Container showing cutting edges and receiving material guides, 105.

FIG. 6 is an end view of a screw in top showing driven flats, 107, rectangular plaque or monument area, 109, flower receptacle, 110 and flag holder, 111.

FIG. 7 is a side view of the screw in top shown in FIG. 6, which fits the hull depicted in FIG. 8, pointing out its driven flats, 107, and threads, 108, to match those inside a hull.

FIG. 8 is a side view of a single piece, non-split hull with receiving material guides, 112, and a body, 102.

FIG. 9 is a side view of a Self Boring Vertical Burial Container being held by a device, 116, on the end of a vehicle arm, 114, and being revolved by a socket wrench, 117, driven in the correct direction by a drive motor, 112, with dug out receiving material, 113, around the hole.

FIG. 10 is a cut away side view of a Self Boring Vertical Burial Container having been dug into a receiving material with some dug out receiving material, 113, around the hole and some dug away receiving material, 115, being guided upward and out through the space between the hole and the hull by guides extending out from the hull.

FIG. 11 is a cut away side view of a Self Boring Vertical Burial Container, now fully installed, showing its top, 116, in its final position after the receiving material around the hull has been tamped, the surplus removed and the ground cover restored.

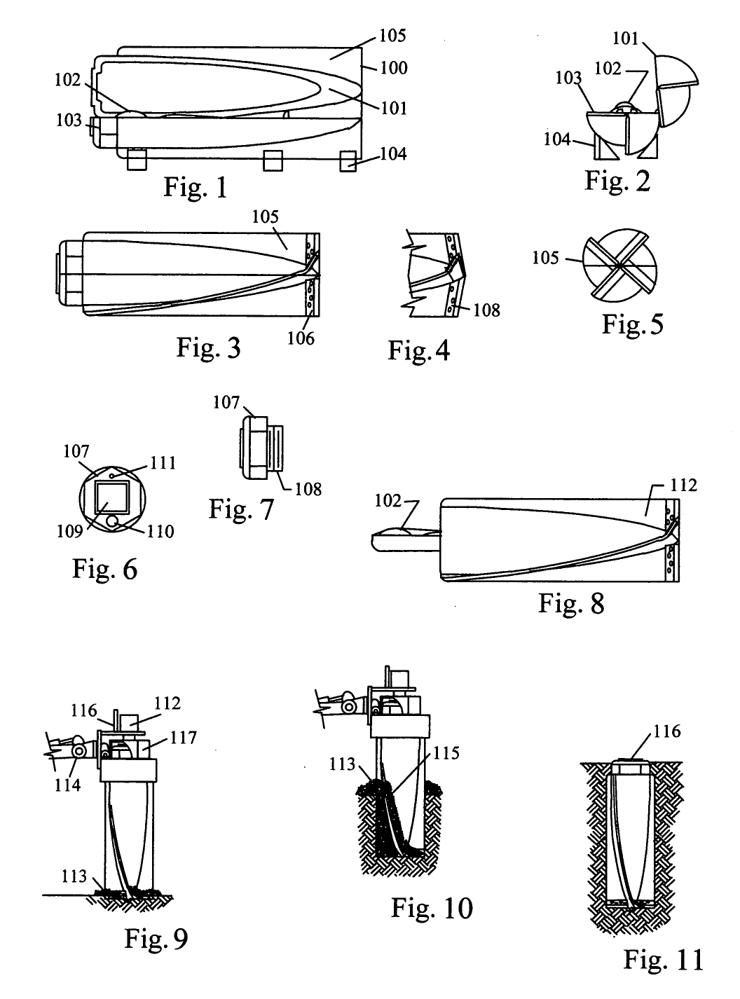

I claim:

1. A burial container hull with at least one cutting element extending outwardly perpendicular to the center line of the main axis of the hull from the lower foot end of the hull to a distance greater than the distance from the center line of the main axis of the hull to the farthest outward point on the upper head end of the hull to give cutaway receiving material space to be guided upward and out of the hole being bored by the burial container.

2. A burial container hull as in claim 1, with a receiving material guide element extending upward from the cutting element along the length of the hull to the upper head end of the hull and extending outwardly from the hull to a distance greater than the distance from the center line of the main axis of the hull to the farthest outward point on the upper head end of the hull to give cutaway receiving material space to be guided upward and out of the hole being bored by the burial container.

3. A burial container hull with at least one cutting element extending outwardly at an angle other than perpendicular to the center line of the main axis of the hull from the lower foot end of the hull to a distance greater than the distance from the center line of the main axis of the hull to the farthest outward point on the upper head end of the hull to give cutaway receiving material space to be guided upward and out of the hole being bored by the burial container.

4. A burial container hull as in claim 3, with a receiving material guide element extending upward from the cutting element along the length of the hull to the upper head end of the hull and extending outward from the hull to a distance greater than the distance from the center line of the main axis of the hull to the farthest outward point on the upper head end of the hull to give cutaway receiving material space to be guided upward and out of the hole being bored by the burial container.

5. A burial container hull with a cutting element and an adjoining guide element extending outwardly from the hull to a distance greater than the distance from the center line of the main axis of the hull to the farthest outward point on the upper head end of the hull to give cutaway receiving material space to be guided upward and out of the hole being bored by the burial container and with the guide element executing a spiral path along the hull as the guide element extends along the hull from the cutting element at the lower foot end of the hull to the upper head end of the hull.
